(19) United States
(12) Patent Application Publication
(10) Pub. No.: US 2025/0202369 A1
(43) Pub. Date: Jun. 19, 2025

(54) ELECTRONIC DEVICE AND METHOD FOR CONTROLLING, WITH CONTROL VIA SYNCHRONIZED TRIANGULAR SIGNAL, AN ELECTRICAL ENERGY CONVERTER COMPRISING A RESONATOR, ASSOCIATED ELECTRICAL ENERGY CONVERSION SYSTEM

(71) Applicant: Commissariat à l’énergie atomique et aux énergies alternatives, Paris (FR)

(72) Inventors: Lucas Henrique DE ARAUJO PEREIRA, Grenoble Cedex 9 (FR); Ghislain DESPESSE, Grenoble Cedex 9 (FR); Adrien MOREL, Grenoble Cedex 9 (FR); Gaël PILLONNET, Grenoble Cedex 9 (FR)

(73) Assignee: Commissariat à l’énergie atomique et aux énergies alternatives, Paris (FR)

(21) Appl. No.: 18/985,803

(22) Filed: Dec. 18, 2024

(30) Foreign Application Priority Data
Dec. 19, 2023 (FR) 2314516

(51) Int. Cl. H02M 3/335; H02M 1/088; H02M 3/00

(52) U.S. Cl. CPC H02M 3/33569; H02M 1/088; H02M 3/01

(57) ABSTRACT

A driving device for a converter from an input voltage to an output voltage, comprising a resonator having an oscillation frequency and successive resonance cycles, and a plurality of switches connected to the resonator. The driving device includes a module for measuring a regulation variable representative of the resonator; a module for controlling a switching of the switches, following a plurality of phases during a resonance cycle, each phase resulting from the closing of at least one switch and the opening of the other switches; and a module for generating a reference triangular signal, regularly synchronized with the regulation variable, a characteristic variable of said triangular signal depending on the oscillation frequency of the resonator. The control module controls at least one of the switches based on a comparison with the reference signal.

The present invention relates to an electronic device for driving an electric energy converter apt to converting an input voltage into an output voltage.

The invention further relates to an electrical energy conversion system comprising such a converter and such an electronic device for driving the converter.

The present invention further relates to a method for driving such a converter.

A converter is known, which includes two input terminals for receiving the input voltage, two output terminals for delivering the output voltage, a resonator, and a plurality of switches connected to the resonator, the resonant resonator following successive resonance cycles, each resonance cycle having a duration equal to a resonance period, the resonance period being equal to the inverse of an oscillation frequency of the resonator.

An electronic driving device is known, comprising a measurement module configured to measure a regulation variable, the regulation variable being a variable representative of the resonator; and a control module configured to control, via a driving unit, a switching of each of the switches, according to a plurality of successive phases during a resonance cycle of the resonator, each phase resulting from the closing of at least one respective switch and/or the opening of at least one switch.

The most interesting feature of such type of converter is the high power density thereof when same operates at a few MHz. Thereof is due to the mechanical and piezoelectric property of the transient energy storage element, which makes it possible to reduce the size thereof in a substantially linear manner with the increase in the drive frequency of the converter, while the inductance exhibits a reduction with a lower rate, as described in the article by P. A. Kyaw and C. R. Sullivan, “Fundamental examination of multiple potential passive component technologies for future power electronics” 2015 IEEE 16th Workshop on Control and Modeling for Power Electronics (COMPEL).

Control strategies, i.e. driving strategies, of DC-DC (Direct current-Direct current) converters with a six-phase piezoelectric resonator during a resonance cycle, with alternation of phases with a substantially constant voltage at the terminals of the resonator and phases with a substantially constant load at the terminals of the resonator, are described in the following articles:
J. J. Piel, J. D. Boles, J. H. Lang and D. J. Perreault, “Feedback Control for a Piezoelectric-Resonator-Based DC-DC Power Converter” 2021 IEEE 22nd Workshop on Control and Modelling of Power Electronics (COMPEL);
B. Pollet, G. Despesse and F. Costa, “A New Non-Isolated Low-Power Inductorless Piezoelectric DC-DC Converter” in IEEE Transactions on Power Electronics, vol. 34, no. 11; and
M. Touhami, G. Despesse, F. Costa and B. Pollet, “Implementation of Control Strategy for Step-down DC-DC Converter Based on Piezoelectric Resonator” 2020 22nd European Conference on Power Electronics and Applications (EPE′20 ECCE Europe).

However, such strategies use numerical control performed via a microcontroller, or a programmable logic component, such as an FPGA (Field Programmable Gate Array), or a configurable logic block (CLB), which has some limitations.

The maximum operating frequency of the controlled converters is limited by the frequency and sampling accuracy of the controller used (e.g. the most commonly used FPGA boards, such as Altera cyclone V, have a maximum frequency limitation of an analog input signal of about 1 MHz, which limits the sampling time resolution of the input signal to a maximum of 4 ns).

The direct control of switch control units, i.e. the measurement of the reference voltage and the direct action thereof through a comparator used at 100 kHz, is not possible at a frequency of 10 MHz due to the delays of the control units (which are longer than the typical duration of a phase of the resonance cycle). Each control unit is apt to apply a control signal to a control electrode, such as a gate electrode, of the associated switch, such as a transistor.

Miniaturization of the converter is limited by the size of the controller, which can be larger than that of the resonator and the power switches thereof. However, microcontrollers or FPGAs have the advantage of being more flexible, being used for adaptations of the controller through programming. Unlike the integrated circuit, microcontrollers or FPGAs can be reprogrammed to make functional changes after being powered up.

The goal of the invention is then to propose an electronic control device, and an associated control method, leading to improved driving of the electric energy converter.

To this end, the invention provides an electronic device for driving an electric energy converter apt to convert an input voltage into an output voltage, the converter including two input terminals for receiving the input voltage, two output terminals for delivering the output voltage, a resonator, and a plurality of switches connected to the resonator, the resonant resonator following successive resonance cycles, each resonance cycle having a duration equal to a resonance period, the resonance period being equal to the inverse of an oscillation frequency of the resonator;

the electronic driving device comprising:
a measuring module configured to measure a controlled variable, the controlled variable being a representative variable of the resonator;
a control module configured to control, via a driving unit, a switching of each of the switches, following a plurality of successive phases during a resonant cycle of the resonator, each phase resulting from the closing of at least one respective switch and from the opening of the other switches;
a generation module configured to generate a reference triangular signal, synchronized regularly with the regulation variable, a characteristic variable of the reference triangular signal depending on the resonator oscillation frequency;
the control module being configured to control at least one of the switches based on a comparison with the reference signal.

With the electronic driving device according to the invention, the triangular reference signal serves to drive with precision the periodic control instants of the switches, in a manner synchronized with the regulation variable which is representative of the resonator, the regulation variable typically being the voltage at the terminals of the resonator.

Furthermore, the slope of the reference triangular signal depends on the resonator oscillation frequency, and is typically proportional to the resonator oscillation frequency, i.e. vibration frequency, which then makes it possible to have the switch switching synchronized with the resonator resonance.

The triangular signal then serves to perform a time-variable conversion where the variable such as a voltage, is the variable of the reference signal, in order to associate with each periodic control instant a corresponding value of the variable on the triangular signal. Such improved precision minimizes switching losses and maintains soft switching conditions, in particular at Zero Voltage Switching (ZVS), which allows the converter to operate optimally at high frequencies.

According to other advantageous aspects of the invention, the electronic control device comprises one or a plurality of the following features, taken individually or according to all technically possible combinations:
the generation module is configured to synchronize the reference signal with the regulation variable at least once per resonance cycle;
the regulation variable is a voltage at the terminals of the resonator;
the reference signal being preferably a triangular voltage;
the triangular reference signal is periodic and ramp-shaped at each period;
the ramp having a period, called the ramp period, the ramp period preferably being equal to the resonance period, the ramp period then being equal to the inverse of the resonator oscillation frequency;
a time instant at the beginning of the period of the reference signal is determined as a function of the controlled variable;
the time instant at which the period begins preferably depending on a time instant at which the time derivative of the control variable is zero;
the period start time instant is anticipated with respect to a switching time instant of a corresponding switch, a time difference between the period start time instant and the switching time instant depending on a processing delay by the driving unit, from the sending of a switching command to the switching of the switch;
the characteristic variable is chosen from the group consisting of: a slope of the reference triangular signal and an amplitude of the reference triangular signal;
when the characteristic variable the slope of the reference triangular signal, the slope of the ramp is proportional to the oscillation frequency of the resonator; the ramp preferably having a fixed amplitude; the slope of the ramp preferably varying further as a function of the oscillation frequency of the resonator when the amplitude of the ramp is fixed;
when the characteristic variable is the amplitude of the reference triangular signal, the amplitude is inversely proportional to the oscillation frequency of the resonator; the ramp preferably having a fixed slope; the amplitude of the ramp preferably varying further as a function of the oscillation frequency of the resonator when the slope is fixed;
the control module is configured to control a plurality of switches one after the other, corresponding to a plurality of phases of the resonance cycle, each control being made on the basis of a respective comparison with the reference signal;
the control module is configured to control each switch at a respective control instant, obtained by comparison with a control signal with the reference signal, and each switch is associated with at least one respective control signal;
a minimum and a maximum stop are predefined for each control signal, the minimum and maximum stops defining minimum and maximum values of the control instant;
the control signal and the reference signal preferably still being voltages, and the minimum and maximum stops then being minimum and maximum voltages;
the switches include:
   a first switch connected between one of the input terminals and the resonator, the first switch being switchable between an open position and a closed position wherein the input voltage is applied to the resonator terminals;
   a second switch connected to the terminals of the resonator, the second switch being switchable between an open position and a closed position wherein the voltage is zero at the terminals of the resonator; and
   a third switch connected between one of the output terminals and the resonator, the third switch being switchable between an open position and a closed position wherein energy from the resonator is returned to the output voltage.
the resonator is a piezoelectric resonator;
the piezoelectric resonator preferably being formed according to one of the constitutions from the group consisting of: a single piezoelectric element; a plurality of piezoelectric elements connected in series; a plurality of piezoelectric elements connected in parallel; a piezoelectric element and an auxiliary capacitor connected in series; a piezoelectric element and an auxiliary capacitor connected in parallel; and an arrangement of a plurality of parallel branches, each branch including one or a plurality of piezoelectric elements connected in series or an auxiliary capacitor.
the auxiliary capacitor also preferably having a capacitance greater, also preferably at least three times greater, than a reference capacitance of the piezoelectric element(s), each piezoelectric element being modeled in the form of a capacitor and of a resonant branch connected in parallel with the capacitor, the reference capacitance being the capacitance of said capacitor;
the control module is configured to control the switching of each of the switches to alternate substantially constant voltage phases at the terminals of the piezoelectric resonator and substantially constant load phases at the terminals of the piezoelectric resonator; and
the resonator is an LC resonator including an inductor and a capacitor connected in series with the inductor.

The invention further relates to an electrical energy conversion system:
an electrical energy converter apt to convert an input voltage into an output voltage, the converter including two input terminals for receiving the input voltage, two output terminals for delivering the output voltage, a resonator, and a plurality of witches connected to the resonator, the resonator resonating following successive resonance cycles, each resonance cycle having a duration equal to a resonance period, the resonance period being equal to the inverse of an oscillation frequency of the resonator; and
an electronic driving device for each electric energy converter; the electronic driving device being as defined hereinabove.

The invention further relates to a method for driving an electric energy converter apt to convert an input voltage into an output voltage, the converter including two input terminals for receiving the input voltage, two output terminals for delivering the output voltage, a resonator, and a plurality of switches connected to the resonator, the resonator resonating following successive resonance cycles, each resonance cycle having a duration equal to a resonance period, the resonance period being equal to the inverse of an oscillation frequency of the resonator;
the method being implemented by an electronic driving device and comprising the following steps:
   measurement of a regulation variable, the regulation variable being a representative variable of the resonator;
   controlling, via a driving unit, of a switching of each of the switches, according to a plurality of successive phases during a resonant cycle of the resonator, each phase resulting from the closing of at least one respective switch and the opening of the other switches,
   generation of a reference triangular signal, synchronized regularly with the regulation variable, a characteristic variable of the reference triangular signal depending on the oscillation frequency of the resonator;
the control of at least one of the switches being performed on the basis of a comparison with the reference signal.

Such features and advantages of the invention will become clearer upon reading the following description, given only as a non-limiting example, and made with reference to the enclosed drawings, wherein:

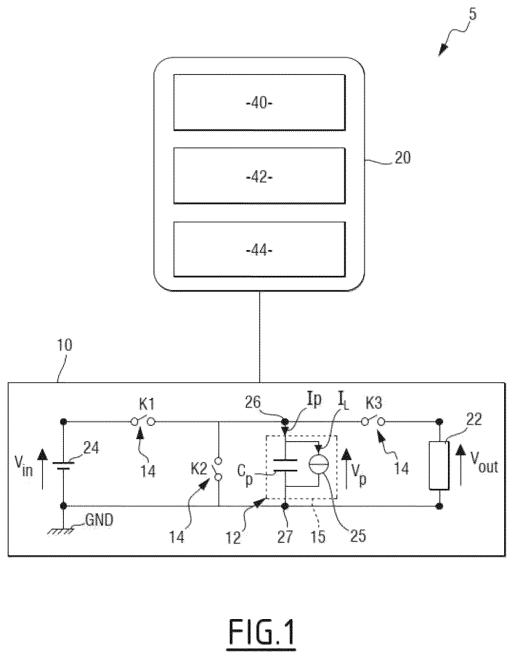

FIG. 1 is a schematic representation of an electronic system for converting electrical energy according to the invention, comprising an electrical energy converter including a resonator and a plurality of switches connected to the resonator; and an electronic device for controlling the electrical energy converter; the resonator being a piezoelectric resonator;

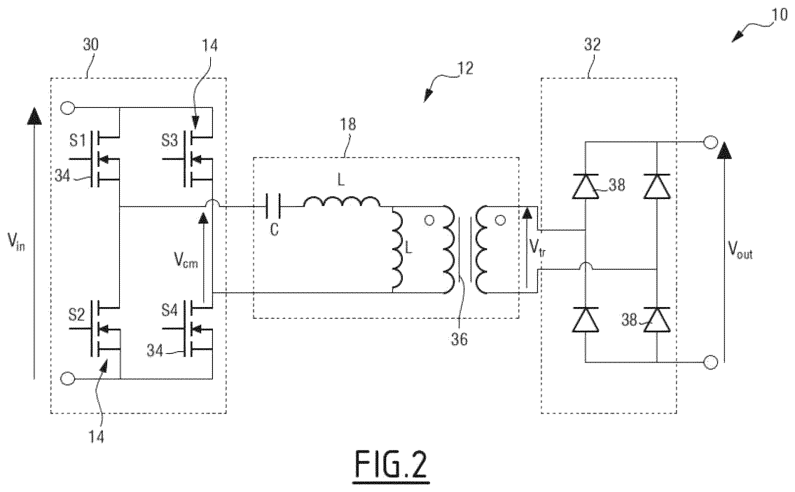

FIG. 2 is a schematic representation of the electrical energy converter when the resonator is an LC resonator;

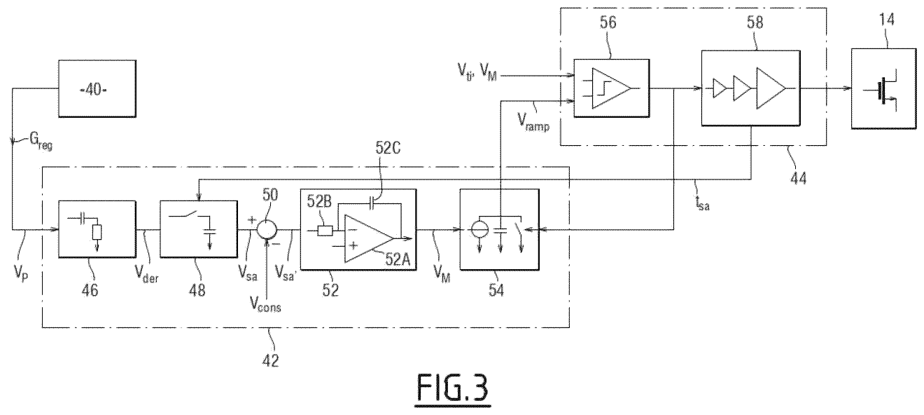

FIG. 3 is a schematic representation of the driving device in FIG. 1;

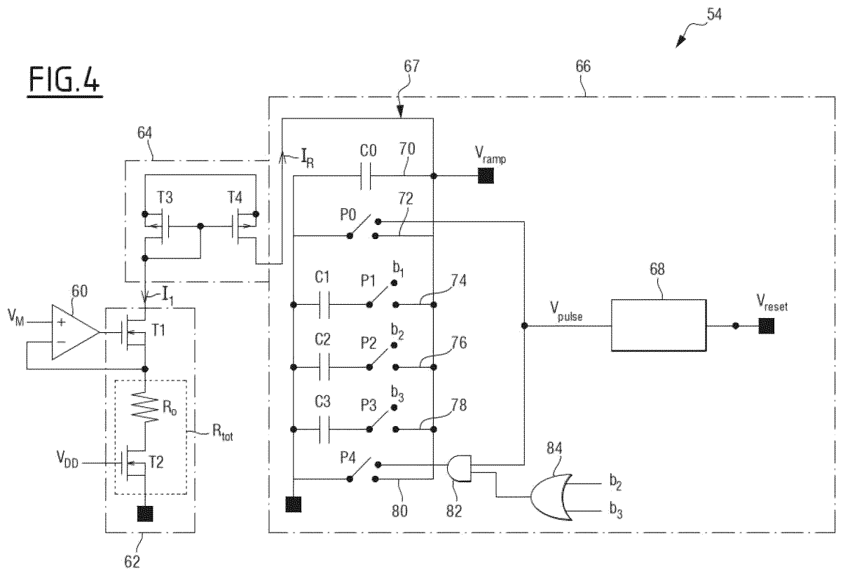

FIG. 4 is a schematic view of a ramp generator,

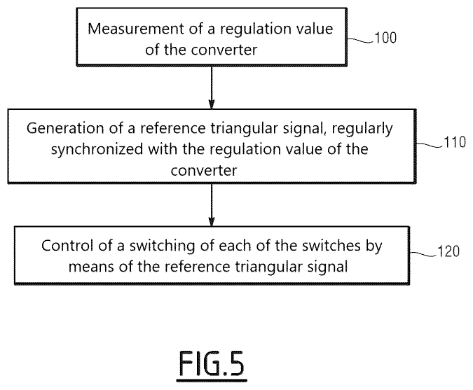

FIG. 5 is an organization chart of a method according to the invention, for driving the electrical energy converter, the method being implemented by electronic driving device shown in FIG. 1;

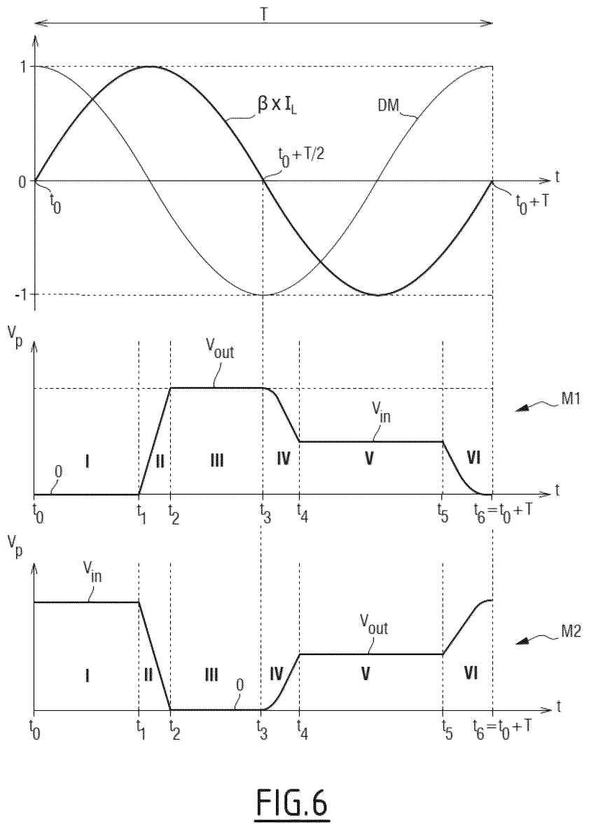

FIG. 6 shows curves of the voltage and current at the terminals of the piezoelectric resonator shown in FIG. 1, in voltage step-up mode, and voltage step-down mode, of the electric energy converter; and

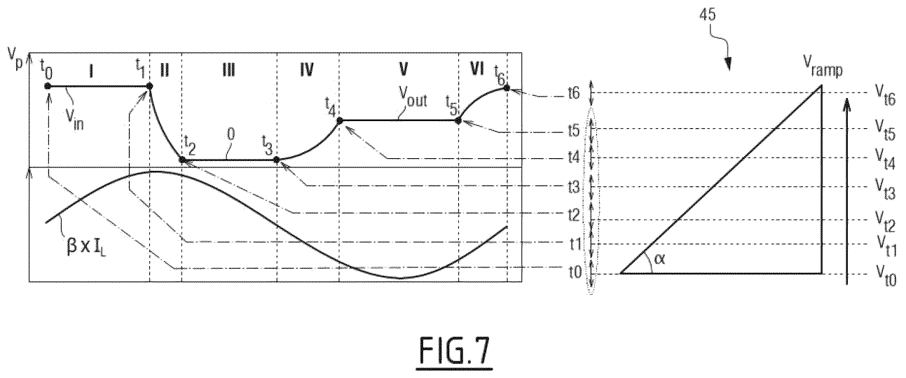

FIG. 7 shows on the left the curve of the voltage and the current at the terminals of the piezoelectric resonator in the voltage step-down mode of FIG. 1, in a manner analogous to FIG. 6; and on the right the curve of a triangular reference signal used to control the switches.

In FIG. 1, an electrical energy conversion system 5 comprises an electrical energy converter 10 including resonator 12 and a plurality of switches 14 connected to the resonator 12. In the example shown in FIG. 1, the resonator 12 is a piezoelectric resonator 15, the switches 14 are denoted by K1, K2, K3. In the example shown in FIG. 2, the resonator 12 is an LLC resonator 18, the switches 14 are denoted by S1, S2, S3, S4.

The conversion system 5 further comprises an electronic device 20 for driving the electric energy converter 10. The electrical energy is typically a voltage, or, in a variant, a current or a power.

The electrical energy conversion system 5 is typically a DC electrical energy conversion system, such as a DC-DC conversion system apt to convert a first DC electrical energy received at the input into a second DC electrical energy delivered at the output, or else an AC-DC conversion system apt to convert an ac electrical energy received at the input into a DC electrical energy delivered at the output of the conversion system 5.

When the electrical energy conversion system 5 is an AC-DC conversion system, the electrical energy conversion system 5 preferentially further comprises a voltage rectifier (not shown) connected to the input of the electric energy converter 10 and apt to rectify the alternating electric voltage received at the input of the conversion system 5 so as to deliver a rectified electric voltage at the input of the converter 10, the electrical energy converter 10 being preferentially a DC-DC converter apt to convert a DC electrical energy into another DC electrical energy. The voltage rectifier is e.g. a rectifier bridge, such as a diode bridge. In a variant, the voltage rectifier is formed in part by switches of the converter 10.

A person skilled in the art would observe that the different examples for the conversion system 5, whether it is a DC-DC conversion system or an AC-DC conversion system, are also presented in documents FR 3 086 471 A1 and FR 3 086 472 A1, in particular with reference to FIGS. 1 to 3, 10, 15, 17 and 19 to 20.

The electrical energy converter 10 is preferentially a DC-DC converter. The purpose of the DC-DC converter is generally to regulate a supply voltage Vₒᵤₜ of a load 22 to a stable variable, by being supplied by a power source 24 supplying a substantially DC voltage Vᵢₙ. The power source 24 is e.g. a battery or a solar panel.

The electrical energy converter 10 is then configured for raising the value of the DC voltage between the input thereof and the output thereof, and is then also called a step-up DC-DC converter, or else a strongly step-up DC converter; or is configured for lowering the value of the DC voltage between the input thereof and the output thereof, and is then called a step-down DC-DC converter, with also as a variant a deep step-down DC-DC converter.

When the electrical energy converter 10 is a step-down DC-DC converter, the value of the input voltage typically corresponds to the voltage Vᵢₙ of the energy source 24, and the value of the output voltage corresponds to the voltage Vₒᵤₜ at the terminals of the load 22, the voltage Vᵢₙ then being greater than the voltage Vₒᵤₜ.

When the electrical energy converter 10 is a step-up DC-DC converter, the value of the input voltage also typically corresponds to the voltage Vᵢₙ of the energy source 24, and the value of the output voltage corresponds to the voltage Vₒᵤₜ at the terminals of the load 22, the voltage Vᵢₙ then being less than the voltage Vₒᵤₜ-When the electrical energy converter 10 is a deep step-down DC-DC converter, the value of the input voltage corresponds, e.g., to the voltage difference (Vᵢₙ−Vₒᵤₜ), and the variable of the output voltage corresponds, e.g., to the voltage Vₒᵤₜ, the voltage difference (Vᵢₙ−Vₒᵤₜ) being markedly greater than the voltage Vₒᵤₜ.

When the electrical energy converter 10 is a step-down DC-DC converter, according to a step-down variant, the value of the input voltage corresponds e.g. to the voltage difference (Vᵢₙ−Vₒᵤₜ), and the value of the output voltage corresponds to the voltage Vₒᵤₜ at the terminals of the load 22, the voltage difference (Vᵢₙ−Vₒᵤₜ) being greater than the voltage out.

The converter 10 includes a plurality of switches 14 apt to be controlled to alternate phases with a substantially constant voltage and phases with a substantially constant load at the terminals of the resonator 12. Such alteration of phases at substantially constant voltage and phases at substantially constant load is typically carried out within periods of substantially constant duration corresponding to the operating frequency of the converter 10, depending on an oscillation frequency, also called natural frequency or else vibration frequency, of the resonator 12. The phases with a substantially constant load make it possible, in the steady state, to switch from one constant voltage to another and to close the switches which have to be closed when the voltage across same is preferentially zero in order to have a so-called zero-voltage switching (ZVS).

Each switch 14 comprises e.g. a transistor and an antiparallel diode (not shown) intrinsic to the transistor.

The transistor is e.g. an insulated gate field effect transistor, also called MOSFET (Metal Oxide Semiconductor Field Effect Transistor). In a variant, the transistor is a bipolar transistor; an insulated gate bipolar transistor, also called IGBT (Insulated Gate Bipolar Transistor); a silicon (Si) transistor, a GaN (Gallium Nitride) transistor; a silicon carbide (SIC) transistor, a diamond transistor, or a thyristor or further mechanical switch such as micro-switch such as a MEMS (MicroElectroMechanical System).

“Substantially constant load” refers to an exchange of a load with the outside which is less than 30% of the load which would have been exchanged with the outside if the voltage would have been kept constant. In other words, “substantially constant load” refers to a load variation of less than 30% of the load which would have been exchanged with the outside of the resonators 12 if the voltage across the resonator 12 would have been kept constant over the time period considered.

“Substantially open electrical circuit” refers to a circuit the possible leakage current of which leads to a variation in the load of the resonator 12 of less than 30% of the load which would have been exchanged with the outside of the resonator 12 if the voltage at the terminals of the resonator 12 would have been kept constant over the length of time considered.

“Substantially constant voltage” refers to a voltage variation of less than 20%, preferentially less than 10%, of the input or output voltage of the converter 10. As an example, if the input voltage of the converter 10 is equal to 100 V, then the voltage variation during each phase with substantially constant voltage, i.e. at each substantially constant voltage step, is less than 20% of said voltage, i.e. less than 20 V; preferentially less than 10% of said voltage, i.e. less than 10 V.

In the example shown in FIG. 1, the driving device 20 is configured for operating the piezoelectric material of the piezoelectric resonator 15 at the resonance thereof in order to exploit phases of load transfer which make it possible to dispense with the use of an inductive element, while regulating the output voltage by maintaining the resonance of the piezoelectric material, i.e. with repeated switching cycles at an operating frequency which is dependent on the oscillation frequency of the piezoelectric resonator 15, and by adjusting the respective switching phase durations within the resonance cycle.

As is known per se, the mechanical oscillation of the piezoelectric resonator 15 is approximately sinusoidal. An increase or decrease in stored energy over a period leads to an increase or decrease in oscillation amplitude, respectively. Moreover, during a phase with a substantially constant load at the terminals of the piezoelectric resonator 15, i.e. when the piezoelectric resonator 15 are placed in a substantially open electrical circuit, with a small exchange of electrical loads between the piezoelectric resonator 15 and the outside, an increase in the amplitude of the oscillations leads to an increase in the rate of variation of the voltage Vₚ at the terminals the piezoelectric resonator 15, and during a phase with a substantially constant voltage at the terminals of the piezoelectric resonator 15, such increase in oscillation amplitude leads to an increase in the current exchanged the piezoelectric resonator 15 and the outside.

In the example shown in FIG. 1, a first switch K1 is connected between one of the input terminals and the piezoelectric resonator 15, the first switch K1 being switchable between an open position and a closed position wherein the input voltage Vᵢₙ is applied to the terminals of the piezoelectric resonator 15.

A second switch K2 is connected to the terminals of the piezoelectric resonator 15, the second switch K2 being switchable between an open position and a closed position wherein the voltage is zero at the terminals of the piezoelectric resonator 15.

A third switch K3 is connected between one of the output terminals and the piezoelectric resonator 15, the third switch K3 being switchable between an open position and a closed position wherein energy from the piezoelectric resonator 15 is given back to the output voltage Vₒᵤₜ.

The oscillation frequency is the frequency at which the resonator 12, such as the piezoelectric resonator 15, oscillates and consequently the current I_{L} thereof on the moving branch (branch R-L-C) thereof of the equivalent model thereof around the selected resonance mode. The current I_{L} can be deduced either by observing the change of the voltage Vₚ when the resonator is isolated or by observing the output current Iₚ thereof during phases at constant voltage. The conversion cycle is synchronized to a mechanical movement of the piezoelectric resonator 15, and the frequency of the control is then adjusted according to the mechanical oscillation frequency. In practice, the oscillation frequency depends on the operating point of the converter 10: values of the three voltage steps and of the output current. As a function of the operating point, the oscillation frequency typically varies between the so-called series resonance frequency of the piezoelectric element (ωs=1/\sqrt{(LC)} where L and C correspond to the inductance and the capacitance of the resonant branch 25 descried hereinafter) and the so-called parallel resonance frequency of the piezoelectric element (ωp=1/{square root over ((L*C*Cp/(C+Cp)))}), also called resonance frequency and antiresonance frequency, respectively, of the piezoelectric resonator 15. The operating frequency of the converter 10 is then comprised between the two resonant and anti-resonant frequencies of the piezoelectric resonator 15. The operating point varies slowly with respect to the oscillation frequency of the piezoelectric resonator 15. The operating point typically evolves at less than 10 kHz, whereas the oscillation frequency of the piezoelectric resonator 15 is typically greater than or equal to 100 KHz. As a result, the operating frequency of the converter 10 varies little from one period to the next.

Furthermore, the lower the output current, the closer the oscillation frequency gets to the piezoelectric resonant frequency, and the higher the output power, the closer the oscillation frequency gets to the piezoelectric antiresonance frequency.

In general, the total number of phases at substantially constant voltage during a resonance cycle is greater than or equal to one in a nominal operating mode of the converter 10.

In the example shown in FIG. 1 where the resonator 12 is the piezoelectric resonator 15, the total number of phases at substantially constant voltage is equal to three in the nominal operating mode of the converter 10. In general, when the resonator 12 is the piezoelectric resonator 15, the total number of phases at substantially constant voltage during a resonance cycle is typically greater than or equal to three.

In the example shown in FIG. 2 where the resonator 12 is the LLC resonator 18, the total number of phases at substantially constant voltage is equal to two in the nominal operating mode of the converter 10. In general, when the resonator 12 is the LLC resonator 18, the total number of phases at substantially constant voltage during a resonance cycle is typically greater than or equal to two. The two substantially constant voltage phases typically correspond to +Vᵢₙ and −Vᵢₙ; or +Vᵢₙ/2 and −Vᵢₙ/2, where Vᵢₙ represents the input voltage of the converter 10.

When, in a variant (not shown), the resonator 12 is the LC resonator of the VHF type, there is typically a single phase at substantially constant voltage in the nominal operating mode of the converter 10, and the converter 10 then typically includes only one switch 14.

The piezoelectric resonator 15 is known per se, and is typically modeled, close to the resonant mode used, in the form of a capacitor Cp and a resonant branch 25 connected in parallel with the capacitor Cp, the capacitor Cp and the resonant branch 25 being connected between first 26 and second 27 electrodes of the piezoelectric resonator 15. The first electrode 26 and the second electrode 27 form the terminals of the piezoelectric resonator 15.

In the example shown in FIG. 1, the piezoelectric resonator 15 further includes a single piezoelectric element.

In a variant (not shown), the piezoelectric resonator 15 includes a plurality of piezoelectric elements connected in series. In a variant, the piezoelectric resonator 15 includes a plurality of piezoelectric elements connected in parallel. In a variant, the piezoelectric resonator 15 includes a piezoelectric element and an auxiliary capacitor connected in series. In a variant, the piezoelectric resonator 15 includes a piezoelectric element and an auxiliary capacitor connected in parallel. In another variant, the piezoelectric resonator 15 includes an arrangement of plurality of parallel branches, each branch including one or a plurality of piezoelectric elements connected in series or an auxiliary capacitor.

According to the concerned variants, the auxiliary capacitor advantageously has greater capacitance, else preferably at least three times greater, than a reference capacitance of the piezoelectric element or elements, such as the capacitance of capacitor Op in the example shown in FIG. 1, each piezoelectric element being modeled in the form of a capacitor and of a resonant branch connected in parallel of the capacitor, the reference capacitance being the capacitance of said capacitor.

In the example shown in FIG. 1, the first switch K1 is connected between a positive input terminal and the first electrode 26 of the resonator 15, the second switch K2 is connected between the first electrode 26 and the second electrode 27 of the piezoelectric resonator 15, and the third switch K3 is connected between the first electrode 26 of the resonator 15 and a positive output terminal and the resonator 15. By positive terminal, the person skilled in the art will understand that same is the terminal of positive polarity, i.e. which is at the highest potential of the input voltage Vᵢₙ, respectively of the output voltage Vₒᵤₜ. In the example shown in FIG. 1, the negative input and output terminals are connected to an electrical ground GND.

The resonant branch 25 is typically an RLC branch formed by an auxiliary capacitor, a resistor and an inductor connected in series (not shown). The voltage Vₚ across the piezoelectric element 15 then typically corresponds to the voltage across the capacitor Cp.

The capacitance of the auxiliary capacitor is advantageously greater than the capacitance of the capacitor Cp, in particular at least three times greater.

In the example shown in FIG. 2, the resonator 12 is the LLC resonator 18, and the converter 10 then forms an LLC resonant converter. The switches 14 are denoted by S1, S2, S3, S4.

The resonant converter LLC includes a switching circuit 30, an LLC resonator 18 and a rectifier 32.

The switching circuit 30 is e.g. in the form of a complete bridge, also called an H-bridge, as can be seen in FIG. 2, or of a half-bridge (not shown). The switching circuit 30 receives as input the voltage Vᵢₙ.

The switching circuit 30, in the H-bridge form thereof, comprises e.g. four transistors 34 forming the switches 14, also denoted by S1, S2, S3, S4. The transistors 34 are e.g. MOSFET transistors, such as N-type depletion MOSFET transistors

The LLC resonator 18 is connected at the output of the switching circuit 30 and is apt to receive at the input, a voltage signal V_{cm}. The LLC resonator 18 comprises two inductances L and a capacitor C connected in a known arrangement to form the LLC resonator. Advantageously, the LLC resonator 18 further comprises a transformer 36 connected to the output of the LLC arrangement and apt to deliver a voltage Var. A person skilled in the art would observe that the inductance L parallel to the input of the transformer is formed, in full or in part, by the magnetizing inductance of the transformer and the inductance L in series is formed, in full or in part, by the leakage inductance of the transformer. A person skilled in the art would also observe that the two inductances L are not necessarily identical and of the same value.

The rectifier 32 is connected to the output of the LLC resonator 18, and then apt to receive the voltage Vₜᵣ as input. The rectifier 32 is configured to rectify an AC voltage into the DC voltage Vₒᵤₜ at the output. In the example shown in FIG. 2, the rectifier 32 is in the form of a diode bridge 38, such as a four-diode bridge 38.

The control device 20 is configured to drive the electrical energy converter 10, and more particularly the switching of the switches 14 of the energy converter.

In the example shown in FIG. 3, the determination device 20 comprises a measurement module 40, a generation module 42, and control module 44 for a respective switch 14.

Advantageously, the driving device 20 comprises a measurement module 40 and a control module 44 for each of the respective switches 14, the generation module 42 then being common to all the switches 14. In other words, in the example shown in FIG. 1 where the energy converter 10 includes three switches 14, the driving device 20 then advantageously comprises the generation module 42 and three driving assemblies, namely a driving assembly for each respective switch 14, each driving assembly including a respective measurement module 40 and a control module 44. For driving a respective switch 14, the associated driving assembly advantageously includes only one measurement module 40 and only one control module 44; and for driving the respective switch 14, the generation module 42 is then connected to the only measurement module 40 and control module 44.

More generally, the driving device 20 comprises plurality of driving assemblies, and the number of driving assemblies is equal to the number of switches 14 the switching of which is driven by the driving device 20. The number of measurement modules 40 and the number of control modules 44 are then each equal to the number of switches 14 driven by the driving device 20. The driving device 20 preferentially comprises only one generation module 42, connected to each of the driving assemblies.

The measurement module 40, the generation module 42, and the control module 44 are each produced, e.g., in the form of an electronic circuit including one or a plurality of electronic components, and in particular comparators when comparisons are made.

In a variant, the measurement module 40, the generation module 42, the control module 44 are each produced in the form of a programmable logic component, such as an FPGA (Field Programmable Gate Array), or in the form of an integrated circuit, such as an ASIC (Application Specific Integrated Circuit) or in the form of a computer, such as a microcontroller, a processor. In another variant, the measurement module 40, the generation module 42 and the control module 44 are implemented together within a single hardware component, such as a single programmable logic component, a single integrated circuit, or a single computer.

The measurement module 40 is configured to measure a regulation variable G_{reg}. The regulation variable G_{reg} is e.g. the voltage Vₚ at the terminals of the resonator 12. In a variant, the regulation variable G_{reg} is another variable representative of the resonator 12, such as the current Iₚ.

The regulation variable is preferably measured just before switching the switch 14. For example, the regulation variable is measured at less than 20 ns, advantageously at less than 2 ns, before the switching at the closing of the respective switch 14.

The generation module 42 is configured to generate a triangular reference signal 45, in preparation for the subsequent use thereof for controlling the respective switch 14.

Advantageously, the reference signal 45 is a periodic triangular voltage Vᵣₐₘₚ forming a ramp at each resonance cycle of the resonator 12.

The ramp formed by the triangular voltage Vᵣₐₘₚ has a ramp period Tᵣₐₘₚ, the ramp period Tᵣₐₘₚ preferably being equal to the resonance period, the ramp period Tᵣₐₘₚ then being equal to the inverse of the oscillation frequency of the resonator 12.

A period start time instant of the reference signal is typically determined as a function of the regulation variable G_{reg}.

The period start time instant of the reference signal depends preferentially on a time instant wherein the time derivative of the regulation variable G_{reg} is zero. When the regulation variable G_{reg} is the voltage Vₚ at the terminals of the resonator 12, the time instant at which the time derivative of the control variable G_{reg} is zero then corresponds to passage through zero of the current I_{L} flowing through the resonator 12, the time derivative of the voltage Vₚ being an image of said current I_{L}.

Advantageously, the period start time instant is anticipated with respect to a switching time instant tᵢ of a corresponding switch, a time difference between the time instant of start of period and the switching time instant t, depending on a processing delay by a driving unit 58 of the respective switch 14, described hereinafter, i.e. the processing delay from the sending of a switching command until the switching of the switch 14.

According to such advantageous aspect, the ramp is advanced by the delay of driving of the switching of the respective switch 14. In other words, the ramp is ahead of the switching of the respective switch 14. Thereof gives agility to all the regulations to compensate for the driving delay, i.e. the delay in implementing the driving unit 58, assuming that the driving delays are substantially identical from one switch 14 to the other.

The reference triangular signal 45 has a characteristic variable G_{car} depending on the oscillation frequency of the resonator 12, the characteristic value G_{car} being chosen from the group consisting of: a slope a of the reference triangular signal 45 and an amplitude Aₘₚ of the reference triangular signal 45.

The control module 44 is configured to control each switch 14 as a function of the reference triangular signal 45, more particularly from a comparison with the reference triangular signal 45.

In the example shown in FIG. 3, the generation module 42 comprises a shunting unit 46, a sampling unit 48, a differential unit 50, a corrector 52 and a ramp generator 54.

The generation module 42 is connected at the output of the measurement module 40 and is apt to receive at the input thereof the regulation quantity G_{reg}, such as the voltage Vₚ at the terminals of the resonator 12. In addition, the generation module 42 is apt to receive a reset command and a value of a sampling instant t_{SA} from the respective switch 14 which is controlled by the driving device 20.

The derivation unit 46 is typically configured to calculate the derivative of an input signal, namely the regulation variable G_{reg}, such as the voltage Vₚ at the terminals of the resonator 12, and by calculating the time derivative thereof, to deliver a voltage V_{der} representative of said time derivative.

The voltage V_{der} is typically an image of the current I_{L} flowing in the resonator 12, being directly proportional to the variable of the current I_{L} when the regulation variable G_{reg} is the voltage Vₚ and the voltage V_{der} then corresponds to dVₚ/dt and considering that the resonator 12 is in open circuit during sampling.

The sampling unit 48 is connected at the output of the bypass unit 46 and to the control module 44, and is then apt to receive at the input the voltage V_{der} and the sampling instant tₛₐ, advantageously at less than 20 ns, advantageously substantially at 1 ns to 2 ns, before the effective switching of the respective switch 14.

The sampling unit 48 is typically configured to choose a sampling duration, e.g. substantially equal to 1% of the total duration of a cycle.

For instance, the sampling instant tₛₐ can be adjusted via a programmable time delay, e.g. integrated into the electronic circuit forming the generation module 42, the time reference typically being a rising or falling signal edge upstream or inside the driving unit 58 of the respective switch 14.

The sampling unit 48 is apt to deliver a voltage Vₛₐ corresponding to the voltage V_{der} sampled at the sampling instant tₛₐ.

The differential unit 50 is connected to the output of the sampling unit 48, and is then apt to receive at the input, the voltage Vₛₐ and a setpoint voltage V_{cons}.

The setpoint voltage V_{cons} advantageously corresponds to the desired setpoint value of the current at the sampling instant tₛₐ, such as the value 0 for the instant to in the example described hereinafter with reference to FIGS. 6 and 7.

The differential unit 50 is intended to deliver a voltage Vₛₐ′ resulting from the difference between the voltages Vₛₐ and V_{cons}.

The differential unit 50 is e.g. in the form of a subtractor, apt to subtract the setpoint voltage V_{cons} from the voltage Vₛₐ to deliver the resulting voltage Vₛₐ′.

The corrector 52 is connected to the output of the differential unit 50, and is then apt to receive at the input, the voltage Vₛₐ′.

The corrector 52 is typically configured to perform a regulation of the periodic switching control instant of the respective switch 14, by receiving at the input thereof the voltage Vₛₐ′ from the sampling unit 48, by calculating an error ε between the voltage Vₛₐ′ and a target voltage, and by then performing an integration of the error ε. The corrector 52 is then apt to deliver a voltage V_{M}.

The corrector 52 comprises e.g. an operational amplifier 52A, a resistor 52B and a feedback loop with a capacitor 52C. The feedback loop connects the output of the operational amplifier 52A to the negative input thereof. The electrical resistor 52B is connected between the input of the corrector 52 receiving the voltage Vₛₐ′ and the negative input of the operational amplifier 52A. Of course, any other type of corrector can be used, e.g. proportional-integral or else proportional-integral-derivative.

The ramp generator 54 is connected to the output of the corrector 52, and is configured to generate the triangular voltage Vᵣₐₘₚ forming a ramp for controlling the respective switch 14, namely a control reference for all the switching instants of the switches 14, the characteristic variable G_{can}, such as the slope a of the ramp, being adapted as a function of the value of the output voltage V_{M} of the corrector 52.

The ramp generator 54 is e.g. intended to adjust the variable of the slope a of the triangular voltage Vᵣₐₘₚ in order to regulate all the switching instants; and to reset the ramp of the triangular tenon Vᵣₐₘₚ to zero.

In said example, the slope a is thus modified as a function of the oscillation frequency of the resonator 12, while keeping constant, the amplitude Amp of the triangular voltage Vᵣₐₘₚ.

In a variant, the ramp generator 54 is intended to adjust the value of the amplitude Amp of the triangular voltage Vᵣₐₘₚ in order to regulate all the switching instants. According to said variant, the amplitude Amp is thus modified as a function of the oscillation frequency of the resonator 12, while keeping constant the slope a of the triangular voltage Vᵣₐₘₚ.

An example of embodiment of the ramp generator 54 is described hereinafter with reference to FIG. 4.

In the example shown in FIG. 3, the control module 44 comprises a comparator 56 and a driving unit 58.

The control module 44 is connected to the output of the generation module 42, and then apt to receive at the input the voltage Vᵣₐₘₚ.

The comparator 56 is connected to the output of the ramp generator 54 and is then apt to receive the voltage Vᵣₐₘₚ.

Advantageously, there are as many control modules 44 as there are switches 14, i.e. half the desired switching instants during the resonance cycle, each switch 14 being switched once to closing and once to opening during the resonance cycle. Each of the switching instants is denoted by tᵢ, i being comprised between 0 and 6 in the example described.

Each switching instant tᵢ is associated with a respective control signal. In the example described, each switching instant tᵢ, is associated with a respective control voltage Vₜᵢ.

In the example described, with each switch 14 are associated, two switching instants tᵢ, and then with each switch 14 are associated two respective control signals.

Each control voltage Vₜᵢ advantageously lies between a minimum stop V_{ti_min} and a maximum stop V_{ti_max}, the minimum stops V_{ti_min} and maximum stops V_{ti_max} being predefined by the user and defining minimum values t_{i_min} and maximum values t_{i_max} of the control instants tᵢ.

The minimum stops V_{ti_min} and maximum stops V_{ti_max} are intended to prevent excessive switching shifts.

Preferentially, it is observed that the maximum stop V_{ti_max} of a current switching instant tᵢ is always less than the minimum stop V_{ti+1_min} of a following switching instant tᵢ₊₁; so that the current instant tᵢ precedes the following instant tᵢ₊₁.

In the example described, the comparator 56 is intended for a plurality of uses depending on whether the duration of the resonance cycle and an initial switching instant t₀ or whether the following switching instants t₁ to t₅ are driven. A person skilled in the art would then understand that the user associated with the comparator 56 depends on the control module 44 to which said comparator 56 belongs, then on the respective switch 14 to which same is associated.

Firstly, for controlling the duration of the resonance cycle and the initial switching instant to, the comparator 56 is intended to deliver a square wave voltage with a high logic level if the voltage Vᵣₐₘₚ Is greater than a predefined voltage V_{M} and with a low logic level if the voltage Vᵣₐₘₚ is less than the voltage V_{M}. The voltage V_{M} is also called the end of ramp voltage.

Secondly, for the control of the following switching instants t₁ to t₅, the comparator 56 is intended, for each switching instant t, corresponding to the respective switch 14 thereof, to deliver a square wave voltage with:
a respective high logic level if the voltage Vᵣₐₘₚ Is greater than:
   the control voltage Vₜᵢ when the voltage Vₜᵢ is comprised between the minimum stop V_{ti_min} and the maximum stop V_{ti_max};
   the minimum stop V_{ti_min} when the control voltage Vₜᵢ is less than the minimum stop V_{ti_min}: or
   the maximum stop V_{ti_max} when the control voltage Vₜᵢ is greater than the maximum stop V_{ti_max}; and
a low logic level otherwise.

In a variant, the corrector 52 directly integrates a voltage limiter V_{ti_min}, V_{ti_max}, e.g. in the case of an integrating corrector, by stopping integrating outside said voltage limits.

The driving unit 58 is connected to the output of the comparator 56 and is then apt to receive at the input thereof the square wave voltage, characterizing an opening or closing control signal, according to the corresponding switching instant.

The driving unit 58 includes e.g., a logic circuit, or an RS (Reset Ser) type flip-flop, or a D type flip-flop, each configured to generate the command for controlling the switch in question from the opening or closing control signals, the rising edge of the closing control signal, denoted by CompOn, indicating the instant of closing of the switch in question and the rising edge of the opening control signal, denoted by CompOff, indicating the instant of opening of the switch in question.

The driving unit 58 then includes e.g. an RS flip-flop with the input S connected to CompOn and the input R connected to CompOff, the output Q delivering the control signal of the switch in question; or a D flip-flop with Reset, with the input D in the high state, the input Clock connected to CompOn and the input R connected to CompOff, the output Q delivering the control signal of the switch in question; or else a logic circuit performing the operation (CompOn and Not(CompOff), the result forming the control signal of the switch in question.

The driving unit 58 is connected to the input of the respective switch 14 and is configured to apply the control signal in opening, or respectively in closing, to a control electrode of the switch 14, such as a gate electrode when the switch 14 includes a transistor such as a MOSFET or an IGBT.

As can be seen in FIG. 4, the ramp generator 54 comprises an operational amplifier 60, a source follower 62, a current mirror 64 and a generation unit 66.

The operational amplifier 60 is connected, by the positive input thereof, to the output of the corrector 52, and is then apt to receive the voltage V_{M}.

The negative input of the operational amplifier is connected to the output of the source follower 62.

The source follower 62 comprises a transistor T1, a transistor T2 and a resistor R₀, the transistor T2 and the resistor R₀ being connected in series and forming an equivalent resistor Rₜₒₜ. The control electrode of transistor T1 is connected to the output of the operational amplifier 60.

A first conduction electrode of the transistor T1 is connected to the negative terminal of the operational amplifier 60 and to the equivalent resistor Rₜₒₜ, a second conduction electrode of the transistor T1 delivering a current I₁.

The operational amplifier 60 is thus intended to compensate for the threshold voltage of the transistor T1, in order to reduce the variation of the current I₁.

By electrical configuration, the current I₁ typically satisfies the following equation:

$${I}_{1} = \frac{{V}_{M}}{{R}_{tot}}$$

where I₁ represents the current at the output of transistor T1 and at the input of current mirror 64,
V_{M} represents the output voltage of the corrector 52,
Rₜₒₜ represents the equivalent resistance formed by the series connection of the transistor T2 with the resistor R₀.

The control of transistor T2 is e.g. connected to a high potential, such as a supply voltage V_{DD}, to keep transistor T2 closed.

The current mirror 64 comprises two transistors T3 and T4, the transistors T3 and T4 being, e.g., PMOS transistors.

The current mirror 64 is connected to the output of the source follower 62 by the connection thereof with the second conduction electrode of the transistor T1 and thus receives the current I₁.

The current mirror 64 is intended to deliver at the output, a current substantially identical to the current I₁, typically to within 5%, whatever the load applied at the output of the current mirror 64.

The current I₁ is applied to the control electrodes of the transistors T3 and T4 and to a first conduction electrode of T3, second conduction electrodes of the transistors T3 and T4 being electrically connected to each other; and a replicated current I_{R} being obtained at a first conduction electrode of T4.

The generation unit 66 comprises a shunt circuit 67 and a pulse module 68.

The generation unit 66 is connected to the output of the current mirror 64, and is then apt to receive at the input the current Iᵣ.

The shunt circuit 67 is intended to deliver the voltage Vᵣₐₘₚ.

The shunt circuit 67 comprises 6 shunt electrical branches 70, 72, 74, 76, 78 and 80, the voltage Vᵣₐₘₚ being at the terminals of each of the electrical branches 70, 72, 74, 76, 78 and 80. Of course, it is possible to use any other number of branch(es) including at least the branch 80, the higher the number of branches, the finer the frequency adjustment and/or over a wide frequency range.

The first branch 70 comprises a capacitor C0.

The value of the capacitor C0 is typically comprised between 0.1 and 10 pF, in particular substantially equal to 0.7 pF.

The second branch 72 comprises a switch P0, the switch P0 being intended to be controlled by the pulse module 68.

The third branch 74 comprises a capacitor C1 and a switch P1, the capacitor C1 and the switch P1 being connected in series.

The value of capacitor C1 is typically comprised between 0.04 and 10 pF, in particular substantially equal to 0.4 pF.

The switch P1 is intended to be controlled by a control bit b₁ predefined by the user, the switch P1 being in the open position when the bit b₁ is equal to 0 and in the closed position when the bit b₁ is equal to 1.

The fourth branch 76 comprises a capacitor C2 and a switch P2, the capacitor C2 and the switch P2 being connected in series.

The value of the capacitor C2 is typically comprised between 0.4 and 50 pF, in particular substantially equal to 4 pF.

The switch P2 is intended to be controlled by a control bit b₂ predefined by the user, the switch P2 being in the open position when the bit b₂ is equal to 0 and in the closed position when the bit b₂ is equal to 1.

The fifth branch 78 comprises a capacitor C3 and a switch P3, the capacitor C3 and the switch P3 being connected in series.

The value of the capacitor C3 is typically comprised between 1 and 150 pF, in particular substantially equal to 12 pF.

The switch P3 is intended to be controlled by a control bit b₃ predefined by the user, the switch P3 being in the open position when the bit b₃ is equal to 0 and in the closed position when the bit b₃ is equal to 1.

The sixth branch 80 comprises a switch P4, the switch P4 being intended to be controlled by the pulse module 68.

The different possible configurations of the shunt circuit 67, due to the plurality of capacitors and switches thereof then make it possible to roughly adjust the value of the slope a of the triangular voltage Vᵣₐₘₚ. Such adjustment of the slope a then serves to define the periodicity of the switching instants of all the switches 14.

For example, such capacitive configuration serves to preset a center frequency. The regulation via the voltage V_{M}, also called the end of ramp voltage, then serves to adjust the frequency around the central frequency. Thereof is a pre-adjustment either in advance or at the start-up of the converter 10 in order to be placed on a frequency band consistent with the piezoelectric resonator 15 on the chosen resonance mode.

For the adjustment, it is possible to proceed as follows:
identify the useful frequency range of the piezoelectric resonator 15;
determine the center frequency of said range;
identify the central variable of the voltage V_{M};
calculate the variable of Cᵣₐₘₚ according to the following equation:

$${C}_{ramp} = \frac{{V}_{M}}{{f}_{ramp} \cdot Δ {V}_{ramp} \cdot {R}_{tot}}$$

where Cᵣₐₘₚ refers to a total value of the capacity of the branches 70, 72, 74, 76, 78 and 80,
V_{M} represents the voltage at the output of the corrector 52, more particularly the aforementioned central variable,
fᵣₐₘₚ designates the frequency of the triangular reference signal 45, more particularly the aforementioned central frequency,
ΔVᵣₐₘₚ=V_{ramp_max}−V_{ramp_min}, where V_{ramp_max} denotes the maximum variable of the voltage ramp Vᵣₐₘₚ, and V_{ramp_min} denotes the minimum variable of said ramp, the variables V_{ramp_max} and V_{ramp_min} being predefined and controlled by the user, and
Rₜₒₜ represents the equivalent resistance formed by the series connection of the transistor T2 with the resistor R₀;
apply the configuration of P1, P2 and P3 which makes it possible to obtain the capacitive value closest to the desired value Cᵣₐₘₚ.

The pulse module 68 is connected to the output of the comparator 56 associated with the regulation of the duration of the resonance cycle, i.e. the regulation of the resonance period, and is then apt to receive at the input thereof, a voltage Vᵣₑₛₑₜ.

The voltage Vᵣₑₛₑₜ is a square wave voltage, having a high logic level if the voltage Vᵣₐₘₚ exceeds the end of ramp voltage V_{M}, and a low logic level otherwise.

The pulse module 68 is intended to discharge the capacitors C0, C1, C2 and C3 when the voltage Vᵣₑₛₑₜ has a high logic level, indicating that the ramp has enabled the switching of all the switching instants and that same has thus to be reinitialized.

The pulse module 68 is intended to drive the switches P0 and/or P4 into the closed position thereof, in order to discharge the capacitors C0, C1, C2 and C3; when the threshold voltage V_{M} making possible the control of the last switching instant is desired.

The pulse module 68 is apt to deliver a voltage Vₚᵤₗₛₑ the time width of which is predefined and makes it possible to choose a discharge duration D of the capacitors C0, C1, C2 and C3.

The discharge time D of the capacitors is typically less than 10 ns, e.g. chosen between 2 ns, 5 ns and 10 ns.

The switch P0 is directly controlled by the voltage Vₚᵤₗₛₑ.

The switch P4 is controlled by means of an AND logic gate 82.

The AND logic gate 82 is connected to the output of the pulse module 68 and of an OR logic gate 84, and is then apt to receive at the input, the voltage Vₚᵤₗₛₑ and a voltage V_{OR}.

The AND logic gate 82 is apt to deliver a voltage V_{AND} at output, the voltage V_{AND} typically also being in the form of a square wave voltage with a high logic level if the voltages Vₚᵤₗₛₑ and V_{OR} have a high logic level, and with a low logic level otherwise. The switch P4 is controlled in the closed position if V_{AND} has a high logic level, or is controlled in the open position if V_{AND} has a low logic level.

The OR logic gate 84 is apt to receive at input, the bit b₂ and the bit b₃, previously defined by the user.

The OR logic gate 84 is apt to deliver at output, the voltage V_{OR}, the voltage V_{OR} typically being in the form of a square wave voltage with a high logic level if b₂ and/or b₃ have(s) a value equal to 1, and with a low logic level otherwise.

For example, the switch P4 is placed as close as possible to the capacitors C2 and C3, because the capacitors C2 and C3 typically have larger capacitances than the capacitors C0 and C1 and require more time to be discharged. The switch P4 is thus only controlled when the capacitor C3 or C4 or both are used for generating the ramp signal.

The frequency fᵣₐₘₚ typically satisfies the following equation:

$${f}_{ramp} = \frac{{V}_{M}}{{C}_{ramp} \cdot Δ {V}_{ramp} \cdot {R}_{tot}}$$

where the parameters are the same as in the preceding equation [2].

The capacitance Cᵣₐₘₚ typically satisfies the following equation:

$${C}_{ramp} = C 0 + {b}_{1} \cdot C 1 + {b}_{2} \cdot C 2 + {b}_{3} \cdot C 3$$

where Cᵣₐₘₚ denotes the total value of the capacitance of the branches 70, 72, 74, 76, 78 and 80, if appropriate supplemented by parasitic capacitances, e.g. the parasitic capacitances of the switches P0 to P4,
C0, C1, C2 and C3 denote the capacitances of capacitors C0, C1, C2 and C3 respectively,
b₁, b₂ and b₃ denote the values of the control bits of switches P1, P2 and P3, respectively (0 for a deactivated capacitor and 1 for an activated capacitor).

In the example described, V_{ramp_min}=0, which leads to ΔVᵣₐₘₚ=V_{ramp_max}, and also V_{ramp_max}=V_{M}, i.e. herein ΔVᵣₐₘₚ=V_{ramp_max}=V_{M}.

The nominal operation of a cycle of the converter 10 comprising a piezoelectric resonator 15 will now be described with reference to FIG. 6 showing the successive phases of a resonance cycle of the piezoelectric resonator, according to a generic format corresponding to different operating modes of the converter 10, namely a first mode of operation M1, also called voltage step-up mode; and a second mode of operation M2, also called voltage step-down mode.

FIG. 6 then shows the change of the current β*I_{L} of the amplitude-normalized current I_{L} flowing through the piezoelectric resonator 15 visible in FIG. 1; of the voltage Vₚ at the terminals of the piezoelectric resonator 15; and of the mechanical deformation of the piezoelectric resonator 15, represented by the curve DM; thereof during a resonance cycle and for two operating modes of the converter 10, namely the first operating mode M1 as a voltage step-up, and the second operating mode m2 as a voltage step-down. With β=−1 in voltage step-up mode M1; and β=+1 in voltage step-down mode M2.

By convention, a first switching time instant is defined, denoted by t₀.

At the time instant t₀, a first phase I begins at a substantially constant voltage, at the zero variable according to the first mode M1 via the closing of the second switch K2, or at the input voltage Vᵢₙ according to the second mode M2 via the closing of the first switch K1, and lasts until a time instant t₁ which forms an adjustment parameter of the converter 10, the time instant t₁ making it possible to define the voltage, the current or else the desired power at the output of the converter 10.

The time instant t₁ then corresponds to the end of the first phase I and to the instant at which the second switch K2 according to the first mode M1, or respectively the first switch K1 according to the second mode M2, must then be open, the time instant t₁ forming a second switching time instant corresponding to the opening of the second switch K2 according to the first mode M1, or respectively of the first switch K1 according to the second mode M2.

A second phase II starts at the second switching time t₁, corresponding to a phase with substantially constant load, or else in substantially open circuit, this second phase II lasting until a time instant t₂ defined by the passage to a new predefined variable of the voltage Vₚ at the terminals of the piezoelectric resonator 15. When the converter 10 includes three switches K1, K2, K3 apt to be controlled to alternate the phases at substantially constant voltage and phases at substantially constant charge at the terminals of the piezoelectric resonator 15, the time instant t₂ forming the end of the second phase II typically corresponds to the closing of the third switch K3 in the first mode M1, or of the second switch K2, respectively, in the second mode M2, the time instant t₂ then forming a third switching time.

A third phase III starts then at the time instant t₂, corresponding to a phase with a substantially constant voltage at the output voltage Vₒᵤₜ according to the first mode M1 via the closing of the third switch K3, or to the zero value according to the second mode M2 via the closing of the second switch K2. The third phase III lasts up to a time instant t₃.

As of the passage through zero of the current I_{L} flowing in the piezoelectric resonator 15 a fourth phase IV then starts corresponding to a phase with substantially constant load, the fourth phase lasting between the time instant t₃ and the time instant t₄. The end of the fourth phase VI corresponds to the moment when the voltage Vₚ at the terminals of the piezoelectric resonator 15 reaches the input voltage Vᵢₙ according to the first mode M1, or to the output voltage Vₒᵤₜ according to the second mode M2.

A fifth switching time instant, denoted by t₄, corresponds to the closing of the first switch K1 for the first mode M1, respectively of the third switch K3 for the second mode M2, and the voltage Vₚ at the terminals of the piezoelectric resonator 15 is then substantially constant and equal to the input voltage Vᵢₙ according to the first mode M1, or to the output voltage Vₒᵤₜ according to the second mode M2. At the fifth switching time t₄ then starts a fifth phase V lasting until the opening of the switch which has been closed at the fifth switching time t₄.

A sixth switching time instant, denoted by t₅, corresponds to the opening of the first switch K1 for the first mode M1, respectively of the third switch K3 for the second mode M2, and the voltage Vₚ at the terminals of the piezoelectric resonator 15 then passes from a preceding voltage Vᵢₙ according to the first mode M1, or Vₒᵤₜ according to the second mode M2, to an open circuit position. At the sixth switching time instant t₅ a sixth phase V1 then begins lasting up to a time instant t₆ corresponding to a passage through zero of the current I_{L} circulating in the piezoelectric resonator 15. Beforehand, the time instant t₅ has been defined so that, at the time instant t₆, the voltage Vₚ across the terminals of the piezoelectric resonator 15 reaches a value making it possible to switch the corresponding switch to zero voltage.

By convention, the time instant t₆ is equal to the sum of the time instant to and the period T of the resonance cycle, and is also denoted by (t₀+T).

In the example shown in FIG. 6, the time instant t₆ corresponds to the end of a resonance cycle of the piezoelectric resonator 15.

The method of controlling an electrical energy converter 10 via the control device 20 will now be described with reference to the flowchart of FIG. 5, the method comprising three distinct steps.

During a first step 100, the measurement module 40 measures the regulation variable G_{reg} of the converter 10. The regulation variable G_{reg} is advantageously the voltage Vₚ at the terminals of the resonator 12.

During a second step 110, the generation module 42 generates the reference triangular signal 45, then synchronizes same with the regulation variable G_{reg} measured by the measurement module 40, the regulation variable G_{reg} depending on the oscillation frequency of the resonator 12.

Advantageously, the generation module 42 synchronizes the reference triangular signal 45 with the regulation variable G_{reg} at least once per resonance cycle, in particular once per resonance cycle.

During a third step 120, the control module 44 receives the triangular reference signal 45 from the generation module 42, more particularly via the ramp generator 54, and controls a switching of each of the switches 14, according to plurality of successive phases during a resonance cycle of the resonator 12, each phase resulting from a switching of at least one respective switch.

The switching times of the different switches 14 are determined by comparison with the triangular reference signal 45.

In the example described, each switching instant t₀, t₁, t₂, t₃, t₄, t₅ or t₆ is connected to a respective control signal, herein a respective control voltage Vₜ₀, Vₜ₁, Vₜ₂, Vₜ₃, Vₜ₄, Vₜ₅ or Vₜ₆. The switch associated with each instant t₀, t₁, t₂, t₃, t₄, t₅ or t₆ is then switched when the voltage Vᵣₐₘₚ corresponding to the reference signal reaches the respective control voltage Vₜ₀, Vₜ₁, Vₜ₂, Vₜ₃, Vₜ₄, Vₜ₅, Vₜ₆, or else the respective minimum stop V_{t0_min}, V_{t1_min}, V_{t2_min}, V_{t3_min}, V_{t4_min}, V_{t5_min}, V_{t6_min} when the respective control voltage Vₜᵢ is lower than said respective minimum strop V_{ti_min}; or else the minimum respective stop V_{t0_max}, V_{t1_max}, V_{t2_max}, V_{t3_max}, V_{t4_max}, V_{t5_max}, V_{t6_max} when the respective control voltage Vₜᵢ is higher than the said respective maximum stop V_{ti_max}; as visible schematically on FIG. 7.

It should be thereby understood that the electronic driving device 20 and the driving method according to the invention make possible a precise driving of the control instants of the switches 14, in a way synchronized with the regulation variable G_{reg} which is representative of the resonator 12.

The high precision of the switching instants obtained by means of the invention then makes it possible to minimize switching losses and to maintain the soft switching conditions, in particular at Zero Voltage Switching (ZVS), which allows the converter 10 to operate optimally at high frequencies.

1. An electronic driving device for driving an electric energy converter apt to convert an input voltage into an output voltage, the converter including two input terminals for receiving the input voltage, two output terminals for delivering the output voltage, a resonator, and plurality of switches connected to the resonator, the resonator resonating following successive resonance cycles, each resonance cycle having a duration equal to a resonance period, the resonance being equal to the inverse of an oscillation frequency of the resonator;
the electronic driving device comprising:
a measuring module configured to measure a regulation variable, the regulation variable being a variable representative of the resonator;
a control module configured to control, via a driving unit, a switching of each of the switches, according to a plurality of successive phases during a resonant cycle of the resonator, each phase resulting from the closing of at least one respective switch and from the opening of the other switches;
a generation module configured to generate a reference triangular signal, regularly synchronized with the regulation variable, a characteristic variable of the reference triangular signal depending on the oscillation frequency of the resonator;
the control module configured to control at least one of the switches based on a comparison with the reference signal.

2. The device according to claim 1, wherein the generation module is configured to synchronize the reference signal with the regulation variable at least once per resonance cycle.

3. The device according to claim 1, wherein the regulation variable is a voltage at the terminals of the resonator.

4. The device according to claim 3, wherein the reference signal is a triangular voltage.

5. The device according to claim 1, wherein the reference triangular signal is periodic and has the shape of a ramp at each period.

6. The device according to claim 5, wherein the ramp has a period, called the ramp period, the ramp period being equal to the resonance period, the ramp period then being equal to the inverse of the oscillation frequency of the resonator.

7. The device according to claim 5, wherein a period start time instant of the reference signal is determined according to the reference variable.

8. The device according to claim 7, wherein the period start time instant depends on a time instant at which the time derivative of the regulation variable is zero.

9. The device according to claim 7, wherein the period start time instant is anticipated with respect to a switching time instant of a corresponding switch, a time difference between the time instant of start of period and the switching time instant depending on a processing time by the driving unit from the issuing of a switching command to the switching of the switch.

10. The device according to claim 1, wherein the characteristic variable is chosen from the group consisting of: a slope of the reference triangular signal and an amplitude of the reference triangular signal.

11. The device according to claim 10, wherein the reference triangular signal is periodic and has the shape of a ramp at each period; and
wherein when the characteristic variable is the slope of the reference triangular signal, the slope of the ramp is proportional to the oscillation frequency of the resonator;
wherein, when the characteristic variable is the amplitude of the reference triangular signal, the amplitude is inversely proportional to the oscillation frequency of the resonator.

12. The device according to claim 1, wherein the control module is configured to control a plurality of switches one after the other, corresponding to a plurality of phases of the resonance cycle, each control being made from a respective comparison with the reference signal.

13. The device according to claim 1, wherein the control module is configured to control each switch at a respective control time instant, obtained by comparing a control signal with the reference signal, and each switch being associated with at least one respective control signal.

14. The device according to claim 13, wherein a minimum and a maximum stop are predefined for each control signal, the minimum and maximum stops defining minimum and maximum values of the control instant.

15. The device according to claim 14, wherein the control signal and the reference signal are voltages, and the minimum and maximum stops then being minimum and maximum voltages.

16. The device according to claim 1, wherein the switches include:
a first switch connected between one of the input terminals and the resonator, the first switch being switchable between an open position and a closed position wherein the input voltage is applied at the terminals of the resonator;
a second switch connected to the terminals of the resonator, the second switch being switchable between an open position and a closed position wherein the voltage is zero at the terminals of the resonator; and
a third switch connected between one of the output terminals and the resonator, the third switch being switchable between an open position and a closed position wherein energy from the resonator is given back to the output voltage.

17. The device according to claim 1, wherein the resonator is a piezoelectric resonator.

18. The device according to claim 17, wherein the piezoelectric resonator is formed according to one of the constitutions from the group consisting of: a single piezoelectric element; a plurality of piezoelectric elements connected in series; a plurality of piezoelectric elements connected in parallel; a piezoelectric element and an auxiliary capacitor, connected in series; a piezoelectric element and an auxiliary capacitor connected in parallel; and an arrangement of a plurality of parallel branches, each branch including one or a plurality of piezoelectric elements connected in series or an auxiliary capacitor.

19. The device according to claim 18, wherein the auxiliary capacitor has a capacitance greater than a reference capacitance of the piezoelectric element or elements, each piezoelectric element being modeled in the form of a capacitor and a resonant branch connected in parallel with the capacitor, the reference capacitance being the capacitance of said capacitor.

20. The device according to claim 17, wherein the control module is configured to control the switching of each of the switches to alternate substantially constant voltage phases at the terminals the piezoelectric resonator and phases with substantially constant load at the terminals of said piezoelectric resonator.

21. The device according to claim 1, wherein the resonator is an LC resonator having an inductor and a capacitor connected in series with the inductor.

22. An electrical energy conversion system comprising:
an electric energy converter apt to convert an input voltage into an output voltage, the converter including two input terminals for receiving the input voltage, two output terminals for delivering the output voltage, a resonator, and plurality of switches connected to the resonator, the resonator resonating according to successive resonance cycles, each resonance cycle having a duration equal to a resonance period, the resonance period being equal to the inverse of an oscillation frequency of the resonator;
an electronic driving device for driving the electric energy converter;
wherein the driving device is according to claim 1.

23. A method for driving an electric energy converter apt to convert an input voltage into an output voltage, the converter including two input terminals for receiving the input voltage, two output terminals for delivering the output voltage, a resonator, and plurality of switches connected to the resonator, the resonator resonating according to successive resonance cycles, each resonance cycle having a duration equal to a resonance period, the resonance period being equal to the inverse of a resonance frequency of the resonator;
the method being implemented by an electronic driving device and comprising:
measurement of a regulation variable, the regulation variable being a representative variable of the resonator;
control, via a driving unit, of a switching of each of the switches, according to plurality of successive phases during a resonance cycle of the resonator, each phase resulting from the closing of at least one respective switch and from the opening of the other switches,
generation of a reference triangular signal, synchronized regularly with the regulation variable, a characteristic variable of the reference triangular signal depending on the oscillation frequency of the resonator;
the control of at least one of the switches being performed on the basis of a comparison with the reference signal.
